(19) United States
(12) Patent Application Publication
(10) Pub. No.: US 2015/0011300 A1
(43) Pub. Date: Jan. 8, 2015

(54) USING ONLINE GAMING CREDITS IN A CASINO GAMING ENVIRONMENT

(71) Applicant: New BIS Safe Luxco S.á.r.l

(72) Inventor: Andrew John Cardno, San Diego, CA (US)

(21) Appl. No.: 14/317,233

(22) Filed: Jun. 27, 2014

Related U.S. Application Data
(60) Provisional application No. 61/842,054, filed on Jul. 2, 2013.

(51) Int. Cl. G07F 17/32

(52) U.S. Cl. CPC G07F 17/3244
USPC 463/25

(57) ABSTRACT

A method of converting online gaming credits into casino gaming credits includes providing a player with online gaming credits. An online game is played using the online gaming credits. Winnings are awarded from the online game as casino gaming credits. A casino game is played using the casino gaming credits. Winnings are paid out from the casino game.

### CROSS REFERENCE TO RELATED APPLICATION

This application claims the benefit of U.S. Provisional Application No. 61/842,054, filed 2 Jul. 2013 and which application is hereby incorporated by reference in its entirety. To the extent appropriate, a claim of priority is made to the above disclosed application.

### BACKGROUND

Gaming casinos typically provide a variety of different games that can be played. Several examples of such games include table games such as blackjack and roulette, slot machines, and video games such as video poker.

Online gambling is gambling that takes place over the Internet. Many of the same games available at gaming casinos can also be played online. Online gambling is increasing in popularity in the United States and in the rest of the world. Players can access online games from the comfort of their home and play over the Internet with friends and other players.

### SUMMARY

In general terms, this disclosure is directed to games of chance involving wagers. In one possible configuration and by non-limiting example, the disclosure relates to awarding gaming credits for casino game play based on winnings from online game play. Various aspects are described in this disclosure, which include, but are not limited to, the following aspects.

One aspect is a method of converting online gaming credits into casino gaming credits, the method comprising: providing a player with online gaming credits; playing an online game using the online gaming credits; and awarding winnings from the online game as casino gaming credits.

Another aspect is a gaming system comprising: a web server computer, the web server computer hosting at least one online game; at least one casino gaming device; and an accounting system, wherein the accounting system manages player accounts, the player accounts including an online gaming credits account, a casino gaming credits account and a cash account, wherein the accounting system is operable to: when the player wins a game on the at least one online game on a wager from the online gaming credits account, award the winnings in the casino gaming credits account; and when the player wins a game on the at least one casino gaming device on a wager from the casino gaming credits account, award the winnings as cash in the cash account.

Yet another aspect is a web server computer comprising: a processing unit; and system memory, the system memory including instructions that when executed by the processing unit cause the web server computer to: assign online gaming credits to a player; receive a wager of the online gaming credits for play of an online game; award winnings to the player from the play of the online game as casino gaming credits; receive a wager of the casino gaming credits with a casino gaming device for play of a casino game; and pay out winnings of the casino game to the player.

### DESCRIPTION OF THE DRAWINGS

FIG. 1 is a schematic flow chart illustrating an example method of game play.

FIG. 2 is a schematic block diagram illustrating an example gaming system.

FIG. 3 is a schematic block diagram illustrating an example of player accounts managed by an accounting system of the gaming system shown in FIG. 2.

FIG. 4 is a diagram illustrating an example of game play according to the present disclosure.

FIG. 5 illustrates an exemplary architecture of a computing device that can be used to implement aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

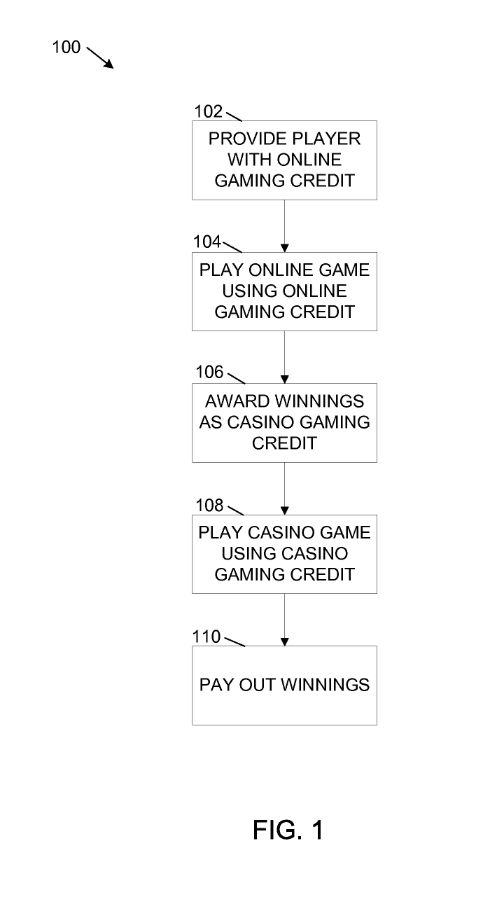

FIG. 1 is schematic flow chart illustrating an example method 100 of game play. In this example, the method includes operations 102, 104, 106, 108 and 110.

In operation 102 a player is provided with an online gaming credit. The online gaming credit permits the player to play an electronic game over the Internet. In some embodiments, the electronic game is an online version of a casino game. Examples of online versions of a casino game include slot machines, video poker and blackjack.

The online versions of the casino game are part of an electronic gaming system which includes casino games played at a casino, for example at a physical casino housed in a building. The casino may sometimes be known as a brick and mortar casino. The electronic gaming system, discussed in more detail herein, manages various aspects or game play, such as managing player accounts. In this disclosure, the terms casino, physical casino and brick and mortar casino may be used interchangeably.

In some embodiments, the online gaming credit is offered as a free play credit to permit the player to play online games at no charge to the player. The free play credit may be offered as a reward for loyal patronage, may be awarded as an incentive to bring in new players, or may be awarded as an incentive to motivate the player to travel to the brick and mortar casino, for example.

The online gaming credit permits the player to play to play the online game just as if the online gaming credit were a cash value. However, in this embodiment, any winnings from playing a game with the online gaming credit are not provided in cash. Instead, any winnings from the online gaming credit are converted into a casino gaming credit that the player can only use at the physical casino. This permits the player to play the game for free, because the money the player is using is free play money. But because any winnings from playing the game are casino gaming credits and not cash, this also provides an incentive for the player to visit the physical casino. At the physical casino, as explained later herein, the casino gaming credits may be converted to cash.

In operation 104, the player plays an online game using the online gaming credit. The game play at operation 104 typically involves a set of rules, and the player is awarded a prize if a set of conditions is met according to the rules. However, as discussed, any winnings from playing the game are awarded as a gaming credit for the physical casino.

In operation 106, the player as awarded winnings as a casino gaming credit. The casino gaming credit is only redeemable at a physical casino. In this embodiment, as explained later herein, the casino gaming credit is not redeemable as cash at the physical casino. Instead, any winnings from using the casino gaming credit at the physical casino may be converted to cash.

In operation 108, the casino gaming credit is used to play one or more casino games at a physical casino. Examples of casino games include electronic games and table games. Several common examples of electronic games include slot machines and video poker games. An example of a table game is roulette. The player is encouraged to travel to the physical casino because the casino gaming credit can only be redeemed at the physical casino.

In operation 110, the player wins at one or more of the casino games. All winnings are paid out as cash to the player.

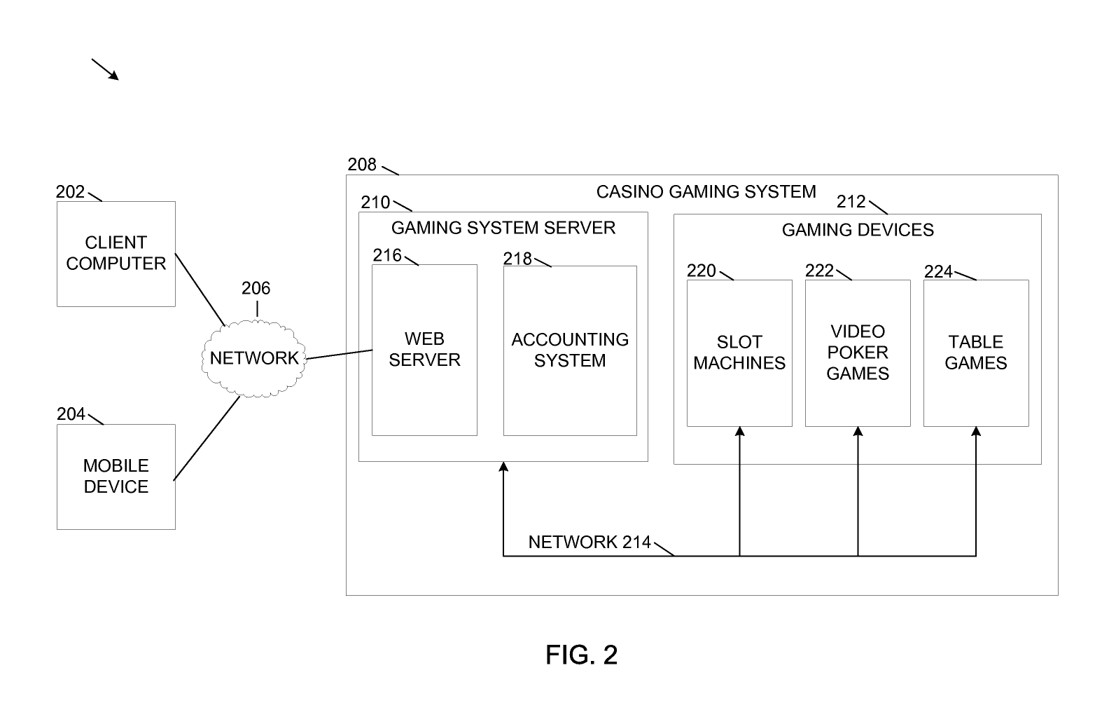

FIG. 2 is a schematic diagram illustrating an example gaming system 200. The gaming system 200 encompasses both an online gaming system and a brick and mortar casino gaming system. In this embodiment, the online gaming system and the casino gaming system are owned by the same entity. In other embodiments, the online gaming system and the casino gaming system may be owned by different entities.

The gaming system 200 includes an online gaming system and a casino gaming system 208. The online gaming system includes a client computer 202, a mobile device 204, a network 206 and a web server 216. The mobile device 204 is typically a smart telephone or a tablet computer. The network is typically the Internet. More than one client computer, mobile device and web server may be used. In this embodiment, the web server 216 is part of a gaming system server computer at the casino gaming system 208. In other embodiments, the web server 216 may be separate and at a different location than the casino gaming system 208.

Web server 216 may render a user interface of the online gaming system at client computer 202 or at mobile device 204. Using a web browser application, the player at client computer 202 or at mobile device 204 may logon to the online gaming system over network 206. Once logged on, the player may be given an online gaming credit to play online electronic games. As discussed, example electronic games that may be played at client computer 202 or at mobile device 204 include slot machines, video poker and blackjack.

The casino gaming system 208 includes a gaming system server 210, gaming devices 212 and network 214. The gaming system server 210 includes web server 216 and an accounting system 218. In this embodiment web server 216 is hosted on gaming system server 210. In other embodiments web server 216 may be hosted and/or physically located elsewhere. In some embodiments, the gaming system server 210 may be remote from gaming devices 212.

A player at the casino interacts with the gaming devices 212 in order to play one or more games. Several examples of gaming devices include slot machines 220, video poker games 222, and table games 224. Other embodiments can include other games as well, such as any of a variety of casino games that involve betting and have payout percentages that can be controlled.

The slot machine 220 typically includes a computing device including a display, a processing device, a computer-readable storage device, a network communication device, and input controls. The input controls may include a lever, and typically include at least several buttons to permit the selection of a wager value and initiation of game play. Various types of slot machines can be used, having a variety of different rules for game play. Commonly the slot machine includes three columns (or reels) in which symbols appear to spin until they come to a stop. The player wins if the symbols stop in one or more predetermined arrangements, such as three of the same symbol arranged in a line.

The video poker games 222 typically include a computing device including a display, a processing device, a computer-readable storage device, a network communication device, and input controls. The input controls are used to place a wager and to provide other inputs utilized during game play. Various poker games can be played on video poker games 222.

Table games 224 typically include a physical table on which a game is played. An example of a table game 224 is a roulette table. A dealer often oversees game play at each of the table games 224. In addition to the table, some embodiments further include a computing device or other electronic device(s) that is used to track game play and check and adjust player accounts. Therefore, in some embodiments the table games 224 also include a computing device, such as including a processing device, a computer-readable storage device, a network communication device, and input controls.

In some embodiments the gaming devices 212 are connected to a data communication network 214. The network can include multiple different communication networks in some embodiments. An example of a network 214 is a local area network. The network 214 can include wireless and/or wired communication systems. The network is also connected to the gaming system server 210 to permit data communication between the gaming devices 212 and the gaming system server 210.

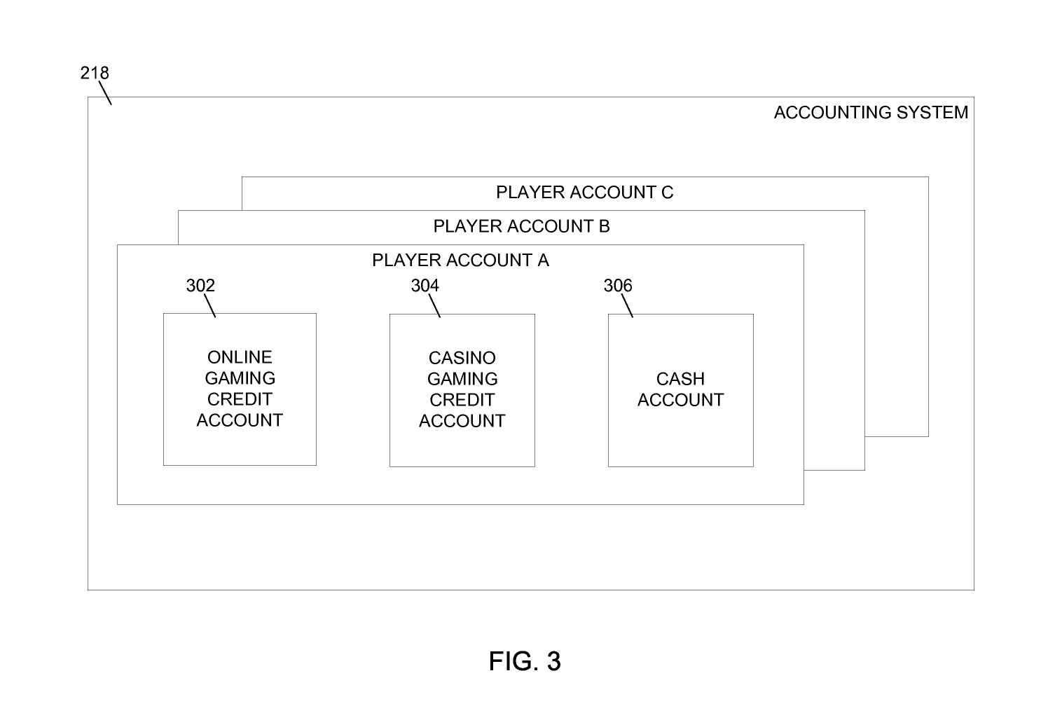

FIG. 3 is a schematic block diagram illustrating an example of the player accounts managed by the accounting system 218 of the gaming system server 210, shown in FIG. 2. In this example, the accounting system 218 is managing player accounts for three players, although any number of player accounts can be similarly managed. More specifically, the accounting system 218 includes a player account A for player A, a player account B for player B, and a player account C for player C.

In this example, the accounting system 218 manages multiple types of accounts for each player, including an online gaming credit account 302, a casino gaming credit account 304 and a cash account 306.

The accounting system 218 keeps track of all transactions that occur that influence the player's cash account 306 balance. The cash account 306 is used to track all transactions that have a cash value for the player. So, for example, if the player makes a deposit with the cashier, the deposit is recorded in the player's cash account 306. In some embodiments, the cash account 306 includes or is associated with a line of credit extended by a casino, which may be guaranteed by a credit card, for example. The accounting system 218 tracks a current balance on the cash account. Typically, the player may choose to remove any remaining balance from (“cash out”) the cash account 306 in the form of cash currency at any time. Other embodiments include other cash payments from the player, and yet other embodiments include other cash payments from the casino or gaming site.

The accounting system 218 also manages the online gaming credit account 302 and the casino gaming credit account 304. The online gaming credit account 302 keeps track of gaming credits that are dedicated for use in online games. For example, a player may be given an initial online gaming credit for use in playing electronic games over the Internet (online games). The player may use all or part of the online gaming credit as a wager for one or more of the electronic games. Each time the player uses the online gaming credit, the value of the online credit in the online gaming credit account 302 is reduced by the amount of the wager.

The casino gaming credit account 304 keeps track of gaming credits that may be used at a physical casino. If the player wins when playing the online electronic game, any winnings are converted to a casino gaming credit for use at a casino. In some embodiments, the casino gaming credit can be used immediately at the casino. In other embodiments, the player needs to wager an amount equal to the initial online gaming credit in order to be able to use the casino gaming credit at the casino.

The example accounting system shown in FIG. 2 can be used, for example, to keep track of game play according to the method shown in FIG. 1. The online gaming credit from operation 102 is added to the online gaming credit account 302. The amount of the online gaming credit used as a wager to play the online game at operation 104 is deducted from the online gaming credit account 302. Winnings from operation 106 are added to the casino gaming credit account 304. All or part of the casino gaming credit account at operation 108 may be used as a wager for a game at a physical casino. Any winnings from playing the game at operation 108 are added to the cash account 306 and may be paid out in cash to the player at any time.

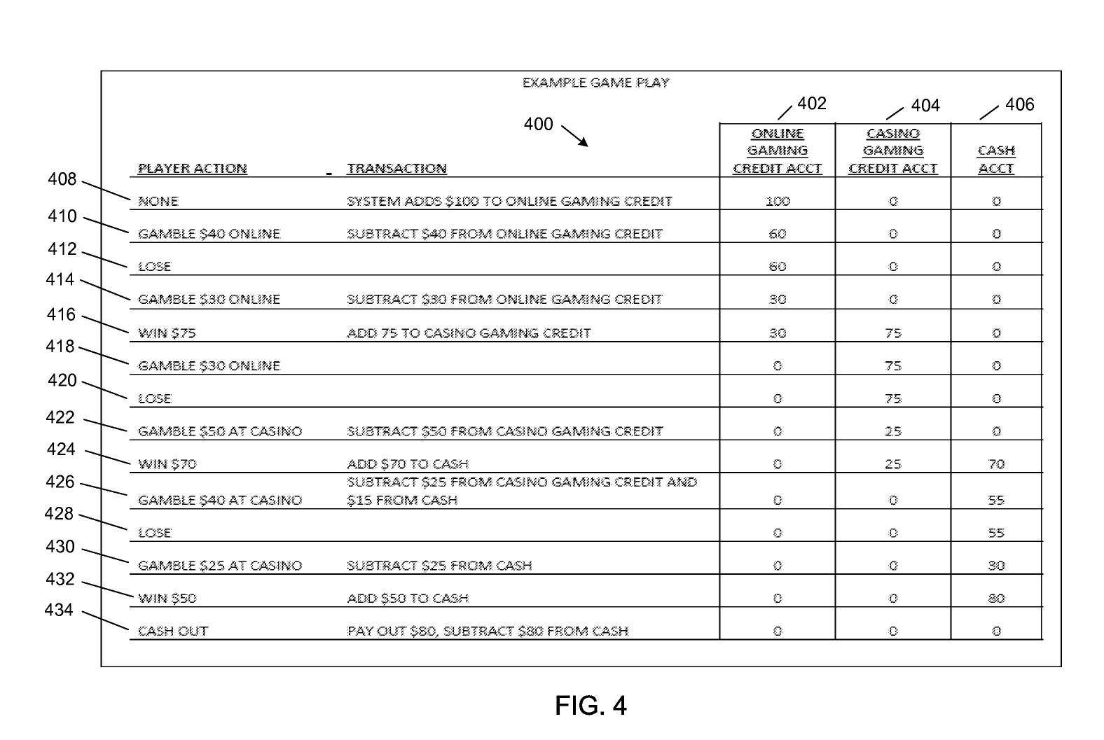

FIG. 4 is a diagram illustrating an example of game play. In some embodiments, the game play proceeds according to the method shown in FIG. 1, which can be implemented, for example, by the gaming system shown in FIG. 2. FIG. 4 also illustrates examples of the transactions managed by the accounting system 218 to manage a player's online gaming credit account 302, casino gaming credit account 304 and cash account 306.

In this example, game play begins with step 408 in which an online gaming credit of $100 is given to a player. When the online gaming credit of $100 is given to the player, the accounting system 218 adds $100 to the online gaming credit account 302, as illustrated on the online gaming credit account 402 column in FIG. 4.

The player then decides in step 410 to gamble $40 online on an electronic game such as a slot machine, for example a slot machine rendered on a web browser of client computer 202 by web server 216. Upon receipt of the bet, the accounting system 218 subtracts $100 from the player's online gaming credit account 302, resulting in a balance of $60.

The player then plays the game, and in step 412 the player loses. As a result, no further adjustments are made by the accounting system 218 in this step.

The player then bets $30 online in step 414, and the accounting system subtracts $30 from the online gaming credit account 302, resulting in a balance of $30.

This time, the player wins the game in step 416, and is awarded $75. The award is paid out in casino gaming credits, and is added to the casino gaming credit account 304, resulting in a balance of $75 in casino gaming credits. No further adjustment is made to the online gaming credit account 402 in this step, which maintains a balance of $30.

The player bets another $30 in step 418. In this case, because the player has online gaming credits available in the online gaming credit account 302, the $30 is subtracted from the player's online gaming credit account 302. At this point the online gaming credit account 302 has a balance of zero.

In step 420, the online game is played and the player loses. As a result, no further adjustments are made by the accounting system 218 in this step.

At this point the player has used all the credits in the online gaming credit account 302. However, the player has $75 in the casino gaming credit account. The player can use this $75 at a physical casino. At some time in the future, the player may travel to a physical casino where the player can use the $75 in the casino gaming credit account.

In step 422, the player bets $50 at the physical casino. The accounting system 218 subtracts $50 from the casino gaming credit account 304, resulting in a balance of $25.

In step 424, the casino game is played at the physical casino and the player wins $70. In this case, because the game was played using a wager of casino gaming credits, the winnings of the game play are awarded as a cash value, and the $70 is added to the player's cash account 306, resulting in a balance of $70.

In step 426, the player bets $40 at the physical casino. However, because the player still has $25 in the casino gaming credit account 404, in some embodiments, the accounting system 218 first subtracts $25 from the casino gaming credit account 404. The player now has a balance of $0 in casino gaming credits. However, because another $15 is needed for the $40 bet, the accounting system 218 also subtracts $15 from the player's cash account 306, resulting in a balance of $55.

In step 428, the casino game is played and the player loses. As a result, no further adjustments are made by the accounting system 218 in this step.

In step 430, the player bets $25 at the physical casino. The accounting system 218 subtracts $25 from the player's cash account, resulting in a balance of $30.

In step 432, the player wins $50. The accounting system 218 adds $50 to the player's cash account, resulting in a balance of $80.

In step 434, the player decides to cash out. As a result, the accounting system 218 subtracts the remaining balance of $80 from the cash account 306, and pays it out to the player.

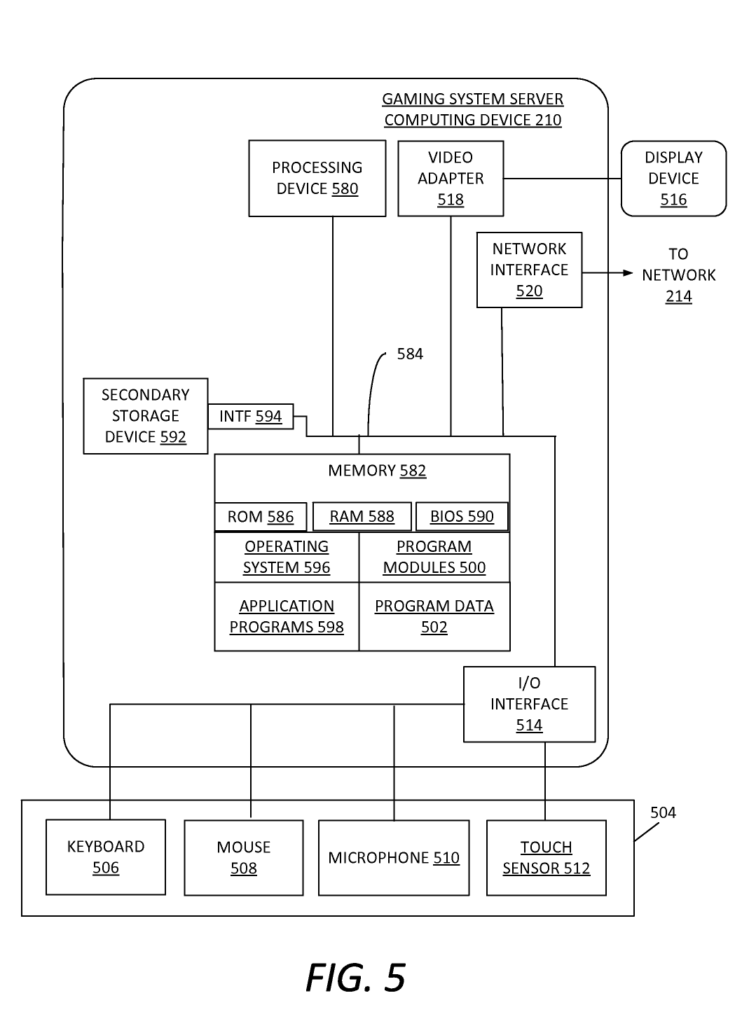

FIG. 5 illustrates an exemplary architecture of a computing device that can be used to implement aspects of the present disclosure, including the gaming system server 210, any of the gaming devices 212 (including slot machine 220, video poker game 222, and table game 224), a player computing device, or any other computing device involved in a system implemented according to the present disclosure. The computing device illustrated in FIG. 5 can be used to execute the operating system, application programs, and software modules described herein. By way of example, the computing device will be described below as the gaming system server 210 computing device. To avoid undue repetition, this description of the computing device will not be separately repeated herein for each of the other computing devices noted above, but such devices can also be configured as illustrated and described with reference to FIG. 5.

The computing device 210 includes, in some embodiments, at least one processing device 580, such as a central processing unit (CPU). A variety of processing devices are available from a variety of manufacturers, for example, Intel or Advanced Micro Devices. In this example, the computing device 210 also includes a system memory 582, and a system bus 584 that couples various system components including the system memory 582 to the processing device 580. The system bus 584 is one of any number of types of bus structures including a memory bus, or memory controller; a peripheral bus; and a local bus using any of a variety of bus architectures.

Examples of computing devices suitable for the computing device 210 include a desktop computer, a laptop computer, a tablet computer, a mobile computing device (such as a smart phone, an iPod® or iPad® mobile digital device, or other mobile devices), or other devices configured to process digital instructions.

The system memory 582 includes read only memory 586 and random access memory 588. A basic input/output system 590 containing the basic routines that act to transfer information within computing device 210, such as during start up, is typically stored in the read only memory 586.

The computing device 210 also includes a secondary storage device 592 in some embodiments, such as a hard disk drive, for storing digital data. The secondary storage device 592 is connected to the system bus 584 by a secondary storage interface 594. The secondary storage devices 592 and their associated computer readable media provide nonvolatile storage of computer readable instructions (including application programs and program modules), data structures, and other data for the computing device 210.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 592 or memory 582, including an operating system 596, one or more application programs 598, other program modules 500 (such as the software engines described herein), and program data 502. The computing device 210 can utilize any suitable operating system, such as Microsoft Windows™, Google Chrome™, Apple OS, and any other operating system suitable for a computing device.

In some embodiments, a user provides inputs to the computing device 210 through one or more input devices 504. Examples of input devices 504 include a keyboard 506, mouse 508, microphone 510, and touch sensor 512 (such as a touchpad or touch sensitive display). Other embodiments include other input devices 504. The input devices are often connected to the processing device 580 through an input/output interface 514 that is coupled to the system bus 584. These input devices 504 can be connected by any number of input/output interfaces, such as a parallel port, serial port, game port, or a universal serial bus. Wireless communication between input devices and the interface 514 is possible as well, and includes infrared, BLUETOOTH® wireless technology, 802.11a/b/g/n, cellular, or other radio frequency communication systems in some possible embodiments.

In this example embodiment, a display device 516, such as a monitor, liquid crystal display device, projector, or touch sensitive display device, is also connected to the system bus 584 via an interface, such as a video adapter 518. In addition to the display device 516, the computing device 210 can include various other peripheral devices (not shown), such as speakers or a printer.

When used in a local area networking environment or a wide area networking environment (such as the Internet), the computing device 210 is typically connected to the network 214 through a network interface 520, such as an Ethernet interface. Other possible embodiments use other communication devices. For example, some embodiments of the computing device 210 include a modem for communicating across the network.

The computing device 210 typically includes at least some form of computer readable media. Computer readable media includes any available media that can be accessed by the computing device 210. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 210. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 5 is also an example of programmable electronics, which may include one or more such computing devices, and when multiple computing devices are included, such computing devices can be coupled together with a suitable data communication network so as to collectively perform the various functions, methods, or operations disclosed herein.

Some embodiments include one or more of the following, or combinations thereof:

A method of game play comprising: providing a player with online gaming credits; playing an online game using the online gaming credits; awarding winnings from the online game as casino gaming credits; playing a casino game using the casino gaming credits; and paying out winnings from the casino game.

A method of converting online gaming credits into casino gaming credits. The method comprises: providing a player with online gaming credits; playing an online game using the online gaming credits; awarding winnings from the online game as casino gaming credits; playing a casino game using the casino gaming credits; and paying out winnings from the casino game.

A gaming system comprising: a web server computer, the web server computer hosts at least one online game; at least one casino gaming device; and an accounting system, wherein the accounting system manages player accounts, the player accounts including an online gaming credits account, a casino gaming credits account and a cash account, wherein the accounting system is operable to: when the player wins a game on the at least one online game on a wager from the online gaming credits account, award the winnings in the casino gaming credits account; and when the player wins a game on the at least one casino gaming device on a wager from the casino gaming credits account, award the winnings as cash in the cash account.

A method of game play including assigning online gaming credits to a player; receiving a wager of the online gaming credits for play of an online game; awarding winnings to the player from the play of the online game as casino gaming credits; receiving a wager of the casino gaming credits with a casino gaming device for play of a casino game; and paying out winnings of the casino game to the player.

A method of game play comprising: providing a player with online gaming credits; playing an online game using the online gaming credits; and awarding winnings from the online game as casino gaming credits.

A web server computer comprising: a processing unit; and system memory, the system memory including instructions that when executed by the processing unit cause the web server computer to: assign online gaming credits to a player; receive a wager of the online gaming credit for play of an online game; and award winnings to the player from the play of the online game as casino gaming credits.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of converting online gaming credits into casino gaming credits, the method comprising:
providing a player with online gaming credits;
playing an online game using the online gaming credits; and
awarding winnings from the online game as casino gaming credits using a computing device.

2. The method of claim 1, wherein playing an online game using the online gaming credits comprises receiving a wager of the online gaming credits for play of the online game.

3. The method of claim 2, further comprising:
losing the wager of the online gaming credits during play of the online game; and
subtracting an amount of the online gaming credits wagered for play of the game from a total of the online gaming credits at the start of the online game.

4. The method of claim 1, wherein providing a player with online gaming credits comprises assigning online gaming credits to a player.

5. The method of claim 4, wherein awarding winnings from the online game as casino gaming credits comprises awarding winnings to the player from the play of the online game as casino gaming credits.

6. The method of claim 1, further comprising:
playing a casino game using the casino gaming credits; and
paying out winnings from the casino game.

7. The method of claim 6, wherein the winnings are paid out as cash.

8. The method of claim 6, wherein, playing a casino game using the casino gaming credits comprises receiving a wager of the casino gaming credits with a casino gaming device for play of the casino game.

9. The method of claim 6, wherein paying out winnings from the casino game comprises awarding winnings to the player from the play of the online game as casino gaming credits.

10. The method of claim 6, further comprising:
losing the wager of the casino gaming credits; and
subtracting an amount of the casino gaming credits from an total of the casino gaming credits at the start of the casino game.

11. A gaming system comprising:
a web server computer, the web server computer hosting at least one online game;
at least one casino gaming device; and
an accounting system, wherein the accounting system manages player accounts, the player accounts including an online gaming credits account, a casino gaming credits account and a cash account, wherein the accounting system is operable to:
when the player wins a game on the at least one online game on a wager from the online gaming credits account, award the winnings in the casino gaming credits account; and
when the player wins a game on the at least one casino gaming device on a wager from the casino gaming credits account, award the winnings as cash in the cash account.

12. The gaming system of claim 11, further comprising: when the player loses the game on the at least one online game, subtract the amount of the wager from the online gaming credits account.

13. The gaming system of claim 11, further comprising: when the player loses the game on the at least one casino gaming device, subtract the amount of the wager from the casino gaming credits account.

14. The gaming system of claim 11, further comprising: when the player loses the game on the at least one casino gaming device, subtract the amount of the wager from the cash account.

15. The gaming system of claim 11, further comprising: when the player loses the game on the at least one casino gaming device, subtract a first part of the wager from the casino gaming credits account and subtract a second part of the wager from the cash account.

16. The gaming system of claim 15, wherein the first part of the wager that is subtracted from the casino gaming credits account is of an amount that causes the casino gaming credits account to have a balance of zero.

17. The gaming system of claim 11, further comprising: receiving an award of a free play credit and increasing the online gaming credits account by the amount of the free play credit.

18. A web server computer comprising:
a processing unit; and
system memory, the system memory including instructions that when executed by the processing unit cause the web server computer to:
assign online gaming credits to a player;
receive a wager of the online gaming credits for play of an online game;
award winnings to the player from the play of the online game as casino gaming credits;
receive a wager of the casino gaming credits with a casino gaming device for play of a casino game; and
pay out winnings of the casino game to the player.

19. The web server computer of claim 18, further comprising:
lose the wager of the online gaming credits during play of the online game; and
subtract an amount of the online gaming credits wagered for play of the game from a total of the online gaming credits at the start of the online game.

20. The web server computer of claim 18, further comprising:
lose the wager of the casino gaming credits during play of the casino game; and
subtract an amount of the casino gaming credits from a total of the casino gaming credits at the start of the casino game.
